(19) United States
(12) Patent Application Publication
(10) Pub. No.: US 2022/0373262 A1
(43) Pub. Date: Nov. 24, 2022

(54) SOLAR ENERGY COLLECTOR SYSTEM

(71) Applicant: Enertopia Corporation, Kelowna, CA (US)

(72) Inventors: Albert Clark Rich, Carmichael, CA (US); Mark E. Snyder, Poway, CA (US); Barry Richard Brooks, Pilot Hill, CA (US)

(21) Appl. No.: 17/751,300

(22) Filed: May 23, 2022

Related U.S. Application Data
(60) Provisional application No. 63/192,458, filed on May 24, 2021.

(51) Int. Cl. F28D 1/02; F28F 23/00; F24S 10/75; H02S 40/44

(52) U.S. Cl. CPC F28D 1/0226; F28D 1/0246; F28F 23/00; F24S 10/753; H02S 40/44; F28F 2280/02

(57) ABSTRACT

A solar energy collector includes an energy dissipating receiver configured to absorb solar energy, an absorption tube that encourages a transfer of heat from the energy dissipating receiver, a base including a groove that receives at least a portion of the absorption tube and supports the absorption tube, and a header that is positioned at least partially within an end of the absorption tube. The absorption tube includes a curved portion and a flat portion. The flat portion faces the energy dissipating receiver.

### CROSS-REFERENCE TO RELATED APPLICATIONS

The present application claims priority to U.S. Provisional Application No. 63/192,458, filed May 24, 2021, and entitled “Solar Energy Collector System,” the entirety of which is incorporated by reference herein.

### FIELD

The current subject matter described herein relates generally to techniques for absorbing solar energy and more particularly to a solar energy collector having an absorption tube.

### BACKGROUND

Generally, photovoltaic panels, such as solar panels, absorb solar energy and convert the solar energy into electrical energy. However, photovoltaic panels can become very hot. Operating at such high temperatures can cause the photovoltaic panels to rapidly degrade, and to inefficiently convert the solar energy into electrical energy. In some instances, cylindrical or entirely round tubes may be used to absorb solar energy directly from the sun, such as when the cylindrical tubes or entirely round tubes are used for heating pools or other heating systems, and/or to absorb heat from photovoltaic panels. For example, the tubes may include a fluid that absorbs the heat from the sun and/or from the photovoltaic panels. However, such cylindrical and/or entirely round tubes, and/or existing systems may be prone to collapsing, may leak, may be difficult to install, may be inefficient, and/or may otherwise fail.

### SUMMARY

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

According to some aspects, a solar energy collector system may include an energy dissipating receiver, an absorption tube, a base, and a header. The energy dissipating receiver may absorb solar energy. The absorption tube may encourage a transfer of heat from the energy dissipating receiver. The absorption tube may include a curved portion, a flat portion, and a channel. The flat portion may face towards the energy dissipating receiver. The channel may extend through a length of the absorption tube and allow a fluid to flow through the absorption tube. The fluid may absorb the transferred heat from the energy dissipating receiver. The base may include a groove configured to receive at least a portion of the absorption tube and support the absorption tube. The header may be positioned at least partially within an end of the absorption tube. The header may direct the flow of the fluid through the channel of the absorption tube.

In some aspects, the energy dissipating receiver includes one or more of a photovoltaic (“PV”) panel and a solar panel.

In some aspects, the curved portion forms at least 50% of a perimeter of the absorption tube.

In some aspects, the curved portion and the flat portion together define a perimeter of the absorption tube.

In some aspects, the absorption tube includes a plurality of absorption tubes.

In some aspects, each of the plurality of absorption tubes are positioned adjacent to one another as part of an array of absorption tubes.

In some aspects, each of the plurality of absorption tubes is separated by a perforation configured to allow for tearing of each absorption tube from the plurality of absorption tubes.

In some aspects, the absorption tube is oriented in a direction that is perpendicular relative to the energy dissipating receiver.

In some aspects, the energy dissipating receiver includes: a first side configured to absorb the solar energy, and a second side opposite the first side. The absorption tube is configured to contact the second side of the energy dissipating receiver.

In some aspects, the energy dissipating receiver includes: a first side configured to absorb the solar energy, and a second side opposite the first side. The absorption tube is configured to be spaced apart from the second side of the energy dissipating receiver by a gap to allow air to flow between the energy dissipating receiver and the absorption tube. The air flowing through the gap is configured to reduce a temperature of the energy dissipating receiver.

In some aspects, the fluid includes one or more of water, antifreeze, and a refrigerant.

In some aspects, the absorption tube includes one or more of a flexible ethylene propylene diene terpolymer (“EPDM”), a rubber, a plastic, a silicon rubber, a thermoplastic with high conductivity, and an elastomer compound with a durometer suitable for rounding out and stretching.

In some aspects, the absorption tube is curved along a length of the absorption tube. The curve is configured to bias the absorption tube against the energy dissipating receiver.

In some aspects, the groove includes a plurality of grooves.

In some aspects, the groove is configured to receive at least a portion of the curved portion of the absorption tube.

In some aspects, a shape of the curved portion corresponds to a shape of the groove.

In some aspects, the base includes an insulation material.

In some aspects, the base includes a surface suitable to receive an adhesive prevent movement of the absorption tube within the groove.

In some aspects, the base includes one or more of a corrugated metal and a molded thermoplastic material.

In some aspects, the header includes a receptacle configured to be inserted into an end of the channel of the absorption tube.

In some aspects, the header includes at least one serrated protrusion extending radially outwardly from an exterior surface of the header. The at least one serrated protrusion is configured to form at least one corresponding groove in the wall of the channel of the absorption tube to secure the header to the absorption tube and to prevent leakage of the fluid from the absorption tube.

In some aspects, the system includes a header ring configured to be positioned around a portion of the absorption tube into which the header is inserted. The header ring is configured to secure the header to the absorption tube.

In some aspects, the header ring includes one or more of a pinch clamp, a hose clamp, a slipover ring, and a mechanically crushed ring.

An array of absorption tubes configured to encourage a transfer of heat from a photovoltaic panel may include a first absorption tube and a second absorption tube. The first absorption tube includes a first curved portion, a first flat portion, and a first channel. The first flat portion is configured to face the photovoltaic panel. The first channel extends through a length of the first absorption tube. The first channel is configured to allow a fluid to flow through the first absorption tube. The fluid is configured to absorb the transferred heat from the photovoltaic panel. The second absorption tube is coupled to the first absorption tube. The second absorption tube includes a second curved portion, a second flat portion, and a second channel. The second flat portion is configured to face the photovoltaic panel. The second channel extends through a length of the second absorption tube. The second channel is configured to allow the fluid to flow through the second absorption tube. The fluid is configured to absorb the transferred heat from the photovoltaic panel. The second channel is fluidly connected to the first channel.

A method of improving a lifespan of a photovoltaic panel, reducing degradation of the photovoltaic panel, and transferring heat from the photovoltaic panel, includes providing an absorption tube to a base of a solar energy collector. The absorption tube is configured to encourage the transfer of heat from the photovoltaic panel. The absorption tube includes: a curved portion, a flat portion, and a channel. The flat portion is configured to face towards the photovoltaic panel. The channel extends through a length of the absorption tube. The channel is configured to allow a fluid to flow through the absorption tube. The fluid is configured to absorb the transferred heat from the photovoltaic panel. The base includes a groove configured to receive at least a portion of the absorption tube and to support the absorption tube. The method also includes attaching the absorption tube to a header. The header is configured to be positioned at least partially within an end of the absorption tube. The header is configured to direct the flow of the fluid through the channel of the absorption tube.

In some aspects, the method includes positioning the absorption tube and the header within a recess between panel rails.

In some aspects, the method includes positioning the photovoltaic panel over the absorption tube.

An array of absorption tubes configured to absorb solar energy includes a first absorption tube including: a first curved portion, a first flat portion, and a first channel, and a second absorption tube including a second curved portion, a second flat portion, and a second channel. The first flat portion is configured to be positioned on a surface. The first curved portion and the first flat portion together define a first perimeter of the first absorption tube. The first channel extends through a length of the first absorption tube. The first channel is configured to allow a fluid to flow through the first absorption tube. The fluid is configured to absorb heat through the first absorption tube from the absorbed solar energy. The second absorption tube is coupled to the first absorption tube. The second flat portion is configured to be positioned on a surface. The second curved portion and the second flat portion together define a second perimeter of the second absorption tube. The second channel extends through a length of the second absorption tube. The second channel is configured to allow the fluid to flow through the second absorption tube. The fluid is configured to absorb heat transferred through the second absorption tube from the absorbed solar energy. The second channel is fluidly connected to the first channel.

In some aspects, the second channel is fluidly connected to the first channel by a collection and/or distribution header.

In some aspects, the perimeter extends around a cross-section of the absorption tube.

In some aspects, the heated fluid from the first absorption tube and the second absorption tube is configured to one or more of heat a pool, be processed for space heating, and feed hot water systems.

In some aspects, the array of absorption tubes is configured to be positioned within a bracket.

In some aspects, the bracket is configured to be coupled to roof of a building.

In some aspects, the described methods absorb solar energy and feed a warmed fluid to a warmed fluid processing system. The described methods may additionally and/or alternatively provide a heated fluid to a lithium processing and/or extraction system.

According to some aspects, a method of absorbing solar energy and feeding a warmed fluid to a warmed fluid processing system may include providing the array of absorption tubes and transferring the warmed fluid from at least one of the first absorption tube and the second absorption tube to the warmed fluid processing system. The warmed fluid processing system may include one or more of pool heating system, a hot water system, a space heating system, and an air conditioning system.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings:

FIG. 1 illustrates an exploded view of a solar energy collector system consistent with implementations of the current subject matter;

FIG. 2 illustrates an exploded view of a solar energy collector system consistent with implementations of the current subject matter;

FIG. 3 illustrates an array of absorption tubes of a solar energy collector consistent with implementations of the current subject matter;

FIG. 4 illustrates an example base of a solar energy collector consistent with implementations of the current subject matter;

FIG. 5 illustrates a cross-sectional view of a header assembly of a solar energy collector system consistent with implementations of the current subject matter;

FIG. 6 illustrates a front view of a header of a solar energy collector system consistent with implementations of the current subject matter;

FIG. 7A illustrates a top view of a header of a solar energy collector system consistent with implementations of the current subject matter;

FIG. 7B illustrates a cross-sectional view of a header assembly of a solar energy collector system consistent with implementations of the current subject matter;

FIG. 9 illustrates a top view of a solar energy collector system consistent with implementations of the current subject matter;

FIG. 10 illustrates a side cross-sectional view of a solar energy collector on a roof of a building consistent with implementations of the current subject matter;

FIG. 11 illustrates a side cross-sectional view of a solar energy collector consistent with implementations of the current subject matter;

FIG. 12 illustrates a close-up view of a solar energy collector consistent with implementations of the current subject matter;

FIGS. 13A and 13B illustrate an example sleeve, consistent with implementations of the current subject matter; and

FIG. 14 is an example method of improving a lifespan of a photovoltaic panel using a solar energy collector consistent with implementations of the current subject matter.

When practical, similar reference numbers denote similar structures, features, or elements.

### DETAILED DESCRIPTION

Generally, photovoltaic panels, such as solar panels, absorb solar energy and convert the solar energy into electrical energy. However, photovoltaic panels can become very hot, especially in climates that are very dry and warm, such as desert climates. Operating at high temperatures can cause the photovoltaic panels to rapidly degrade, and to convert the solar energy into electrical energy less efficiently. Thus, operating photovoltaic panels at high temperatures may cause the panels to be replaced or repaired more often.

For example, photovoltaic panels convert solar energy into useful electrical current. The photovoltaic panels may be rated convert the solar energy into electrical energy at a rate of 15-20% effectiveness. The remaining solar energy (e.g., the solar energy that is not converted into electrical energy) is converted into heat, which may reduce performance of the photovoltaic panel, degrade the photovoltaic panel, and/or reduce a lifespan of the photovoltaic panel. In some instances, the optimal temperature for a face of a photovoltaic panel is 77 degrees Fahrenheit. Every degree (e.g., 1° F., 1.8° F., and/or the like) above 77 degrees Fahrenheit reduces the current output of the panel by approximately 0.5% to 1%. In some instances, 50% of the unused conversion energy transfers to the back of the photovoltaic panel and 50% of the unused conversion energy dissipates off the face of the photovoltaic panel. The temperature of the back face of the photovoltaic panel may thus reach at least 50 degrees higher than the optimal temperature (e.g., 140 degrees Fahrenheit or higher).

Such circumstances may be is especially true in hot dry climates, where the difference in temperature can be 75 degrees between night and day temperatures. With it being common for photovoltaic panels to reach temperatures of 137° F., a solar array being 60° F. greater into the heat stress zone would equal a decrease of 15% or more on the output. Nevertheless, regardless of the geographic location of the photovoltaic panel and the time of year, waste heat is produced when solar energy is converted into electrical energy. With over 1.2 TW (Terawatts) of worldwide photovoltaic panel installed capacity, and another 100 Gigawatts of photovoltaic panel capacity coming online per year, the inefficiencies that are currently experienced due to overheating are quite extensive, and expensive. Accordingly, the waste heat reduces performance of the photovoltaic panel, degrades the photovoltaic panel, reduces an output of the photovoltaic panel, and/or reduces a lifespan of the photovoltaic panel.

The solar energy collector system consistent with implementations of the current subject matter may reduce the operating temperature of the photovoltaic panels, by for example, quickly and efficiently transferring heat from the photovoltaic panels to the solar energy collector system. Thus, the solar energy collector system described herein may extend the lifespan of the photovoltaic panels and reduce degradation of the photovoltaic panels.

In some instances, cylindrical tubes or entirely round tubes may be used to absorb heat from the photovoltaic panels and/or absorb solar energy directly from the sun, such as via a fluid flowing through the cylindrical or entirely round tubes. However, such tubes may be prone to collapsing, may leak, may be difficult to install, and/or may otherwise fail. The solar energy collector system consistent with implementations of the current subject matter includes at least one absorption tube having a curved portion and a flat portion. Such configurations help to prevent or limit collapsing of the absorption tube, thereby preventing failure of the solar energy collector system and helping to reduce leakage from the solar energy collector system. Consistent with implementations of the current subject matter, the solar energy collector system may additionally and/or alternatively include a base with at least one groove to receive the curved portion of the at least one absorption tube. The base helps to support the absorption tube and further prevent or limit collapsing of the absorption tube.

As described herein, the flat portion and the curved portion of the absorption tube of the solar energy collector system consistent with implementations of the current subject matter may together form a perimeter of the absorption tube (e.g., a single absorption tube). Such configurations may eliminate the need for webbing or other mechanical features used to support the structure of the tubes and/or help to prevent collapsing of the tubes. Such configurations may also help to maximize a heat transfer surface that is exposed to the heat (e.g., the flat portion exposed to the photovoltaic panels and/or the curved portion exposed to direct sunlight). This help to transfer heat from the photovoltaic panels more quickly and efficiently to reduce the operating temperature of the photovoltaic panels. Additionally and/or alternatively, such configurations help to improve heat transfer efficiency and speed to the fluid flowing through the absorption tubes of the solar energy collector system. Such configurations help to reduce the operating temperature of the photovoltaic panels more quickly and/or help to heat the fluid flowing through the absorption tubes more quickly. This allows for the heated fluid to be delivered to another system, such as an air conditioning system, a pool heating system, lithium processing or extraction systems, battery management systems (e.g., stored in batteries), and/or another heat processing system, more quickly and efficiently.

In some implementations, the absorption tubes consistent with implementations of the current subject matter may be coupled together to define an array of absorption tubes (e.g., a mat, such as a rollable mat). The array of absorption tubes may be easily manufactured, assembled, and/or installed. For example, the array of absorption tubes may be unrolled and installed into the proper position, on a surface, such as a roof, a pool, and/or the like, and/or onto a base configured to receive the mat. As described herein, each absorption tube of the array of absorption tubes may be torn from the array of absorption tubes along a perforation to allow for the mat to better fit within an allotted space. Thus, the absorption tubes may be easily and quickly installed. The array of absorption tubes and/or the individual absorption tubes described herein may be positioned in any orientation and/or direction.

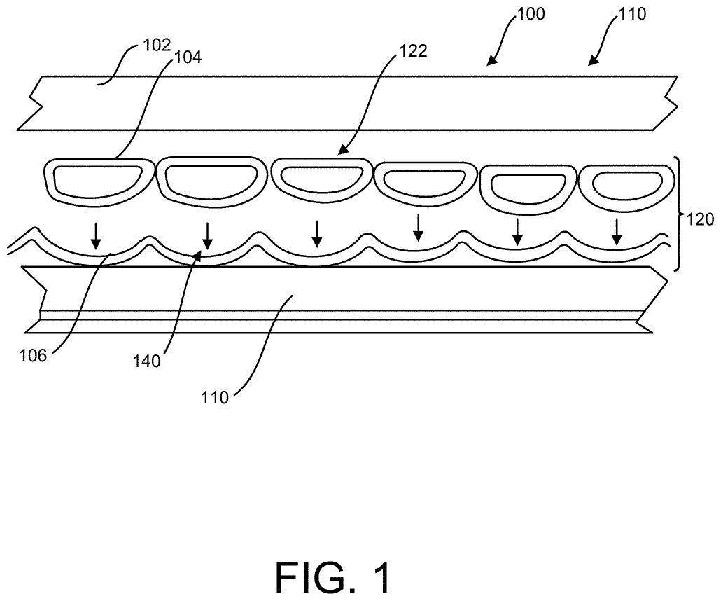

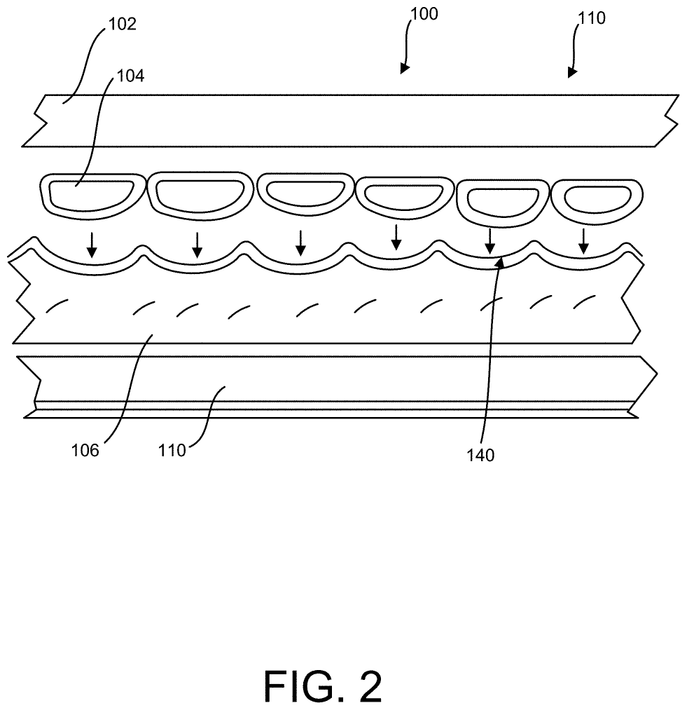

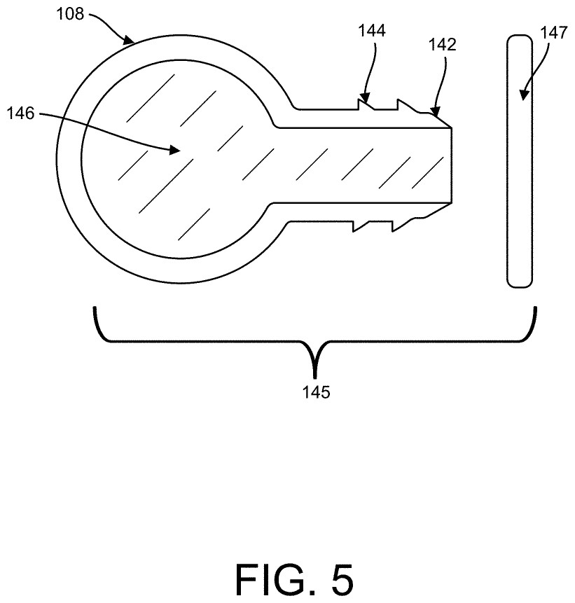

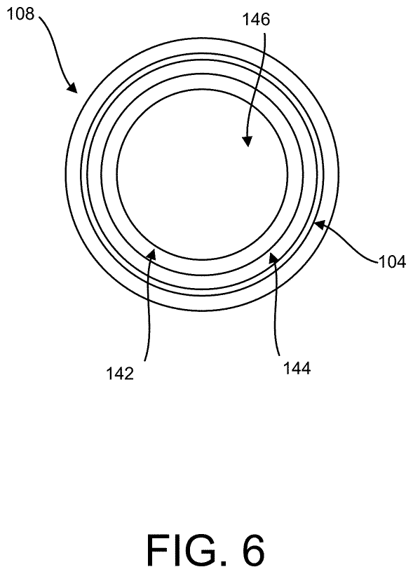

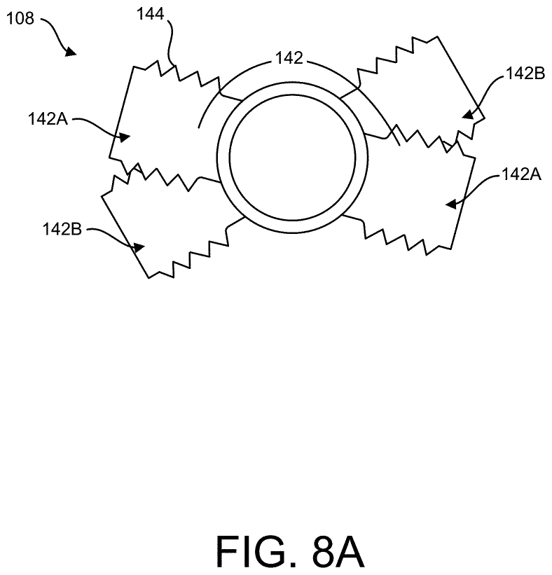

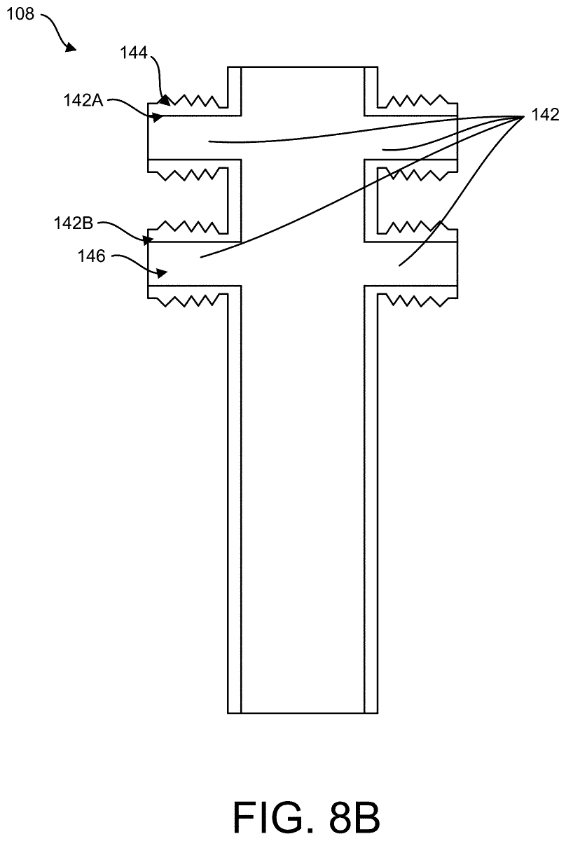

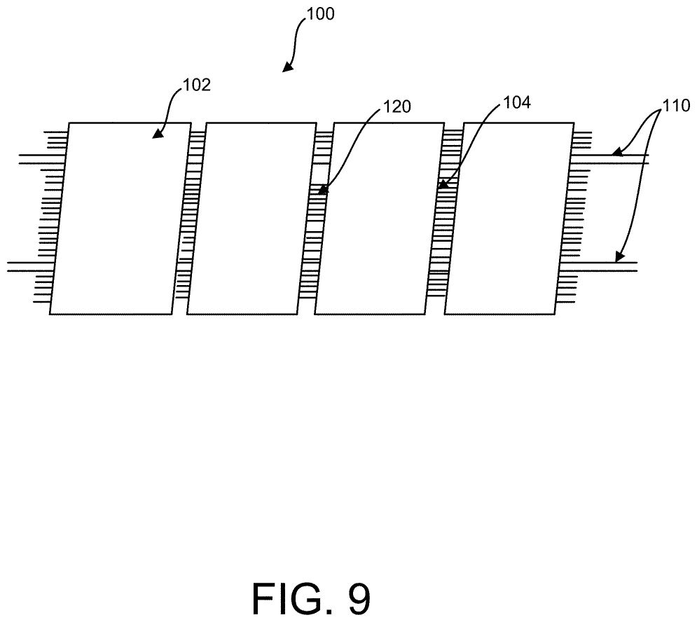

FIG. 1 and FIG. 2 illustrate exploded views of a solar energy collector system 100, consistent with implementations of the current subject matter. The solar energy collector system 100 may include a thermal energy transfer system, and/or the like. The solar energy collector system 100 may include an energy dissipating receiver 102, an absorption tube 104, a base 106, and/or a header 108 (see FIG. 5 and FIG. 6). The system 100 may additionally and/or alternatively include one or more rails 110 (see FIG. 9), that may support all or a portion of the energy dissipating receiver 102, the absorption tube 104, the base 106, and/or the header 108. As described herein, in some implementations, the solar energy collector system 100 includes the absorption tube 104 and/or the header 108, and may not include the energy dissipating receiver 102 and/or the base 106.

The absorption tube 104, the header 108, and/or the base 106 may together (or separately) form a solar energy collector 120. In some implementations, the solar energy collector 120 may be used to improve the efficiency of the energy dissipating receiver 102, the life expectancy of the energy dissipating receiver 102, reduce degradation of the energy dissipating receiver 102, and/or the like. Additionally and/or alternatively the solar energy collector 120 may be used to heat a fluid flowing through the solar energy collector 120 and to feed the heated fluid to another system, such as a warmed fluid processing system including a pool, an air conditioning system, a space heating system, a hot water processing system, a lithium processing and/or extraction system, battery management systems (e.g., stored in batteries), and/or the like. Additionally and/or alternatively, the solar energy collector 120 may be used for dissipating heat at night, or another time of day.

In some implementations, the solar energy collector 120 may be used in a residential and/or a commercial setting. The solar energy collector 120 may be used with a thermal battery of the system 100. The thermal battery may be an energy storage for temporarily storing and releasing thermal energy. The solar energy collector 120 may be coupled to the thermal battery to allow for the thermal battery to collect waste heat from the solar energy collector 120 and to later release the thermal energy. As an example, the thermal battery may collect the waste heat from the solar energy collector 120 during the day when ambient temperatures are warmer, and release the waste heat at night when ambient temperatures are cooler. The release waste heat can be fed to another system and/or released to atmosphere. Such systems including the thermal battery may be useful, such as when a body of water, such as a pool, is not available for releasing waste heat.

In some implementations, the solar energy collector 120 and/or the thermal battery may be used in phase change applications. For example, lithium salts, crystals, molten salts, wax, or other mediums may be used to create a phase change. This allows for a greater amount of heat to be absorbed. The absorbed heat, in turn, can be returned to the energy dissipating receiver 102, to improve efficiency of the energy dissipating receiver 102.

For example, the solar energy collector 120 may cool the energy dissipating receiver 102 via a fluid flowing through the solar energy collector 120 absorbing or otherwise removing heat from the energy dissipating receiver 102. This reduces the operating temperature of the energy dissipating receiver 102, thereby improving the efficiency and life expectancy of the energy dissipating receiver 102 and reducing degradation of the energy dissipating receiver 102.

In some implementations, the solar energy collector 120 may be used without the energy dissipating receiver 102. In such implementations, the solar energy collector 120, such as via the fluid flowing through the solar energy collector 120, may absorb heat and/or solar energy directly, to warm the fluid flowing through the solar energy collector 120.

When the solar energy collector 120 is used with and/or without the energy dissipating receiver 102, the warmed fluid flowing through the solar energy collector 120 may be fed to another system. For example, the warmed fluid may be fed to an air conditioning system, to a pool to heat the pool water, to a lithium processing and/or extraction system, battery management systems (e.g., stored in batteries), and/or the like. The solar energy collector 102 may additionally and/or alternatively be used to reduce a temperature of a roof of a building. For example, the solar energy collector 102 may absorb heat from the roof of the building and/or limit or prevent heat from entering the roof. For example, the fluid flowing through the solar energy collector 120 may absorb the heat and be directed away from the roof of the building.

Referring to FIG. 1 and FIG. 2, the energy dissipating receiver 102 may include a photovoltaic (“PV”) panel, such as a solar panel and/or a photovoltaic-thermal. For example, the energy dissipating receiver 102 may generate thermal energy and/or electrical energy by converting absorbed solar energy into the thermal energy and/or the electrical energy. In some implementations, the generated thermal energy and/or electrical energy may be used to heat water, a refrigerant, and/or antifreeze, heat pool water, feed air conditioning systems, feed lithium processing and/or extraction systems, battery management systems (e.g., stored in batteries), and/or the like.

Referring again to FIG. 1 and FIG. 2, the solar energy collector system 100 may include an absorption tube 104. The absorption tube 104 may form all or a part of the solar energy collector 120. The absorption tube 104 may encourage a transfer of heat to a fluid flowing through the absorption tube 104. For example, the absorption tube 104 may encourage a transfer of heat from the energy dissipating receiver 102 to the fluid flowing through the absorption tube 104.

In some implementations, the absorption tube 104 may extend in a direction that is perpendicular relative to the energy dissipating receiver 102. For example, the energy dissipating receiver 102 may be oriented in a first direction, and the absorption tube 104 may be oriented in a second direction that is perpendicular to the first direction (see FIG. 9). In some implementations, the absorption tube 104 may extend in a direction that is approximately 90 degrees, 180 degrees, 270 degrees and/or parallel to the direction of the energy dissipating receiver 102.

The absorption tube 104 may be an elongated tube. For example, the absorption tube 104 may be between 1 to 2 feet long, 2 to 5 feet long, 5 to 10 feet long, 10 to 25 feet long, 25 to 50 feet long, 50 to 100 feet long, 100 to 120 feet long, 120 to 150 feet long, 150 to 200 feet long, and/or other ranges therebetween.

In some implementations, the absorption tube 104 includes an array 122 of absorption tubes 104. The array 122 may include a plurality of absorption tubes 104. The plurality of tubes may be coupled together and/or integrally formed to define a mat. The mat may be un-rolled and/or otherwise positioned to install the mat.

For example, the array 122 may include one, two, three, four, five, six, seven, eight, nine, ten, or more absorption tubes 104. As part of the array 122, each of the plurality of absorption tubes 104 may be positioned adjacent to one another. For example, the absorption tubes 104 may include a first end 132, a second end 134, and a tube 136 that extends between the first end 132 and the second end 134. The tube 136 may extend lengthwise between the first end 132 and the second end 134. Each of the tubes 136 may be positioned adjacent to one another and/or may be coupled to one another along the length of the tubes 136. In some implementations, each of the plurality of absorption tubes 104 may be separated by a perforation that allows for tearing of each absorption tube 104 from the array 122.

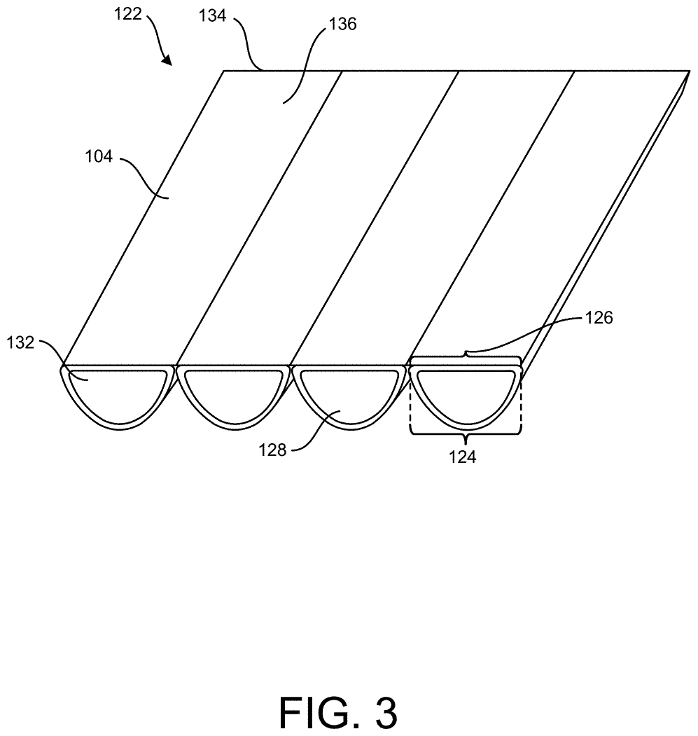

FIG. 3 illustrates an example of the array 122 of absorption tubes 104, consistent with implementations of the current subject matter. Each absorption tube 104 may include a curved portion 124 and a flat portion 126. The absorption tube 104 may also include a channel 128 extending through a length (e.g., the entire length) of the interior of the absorption tube 104. The channel 128 allows the fluid, such as water, antifreeze, refrigerant, and/or the like, to flow through the absorption tube 104 and absorb the transferred heat from the sun and/or from the energy dissipating receiver 102. The fluid may be recycled within the absorption tube 104 (or array 122), for example, as part of the closed loop system. For example, the fluid may absorb the heat from the energy dissipating receiver 102, may eject the heat (e.g., as part of a downstream system, such as an air conditioning system, a space heating system, a pool, a heat processing system, a lithium processing or extraction system, and/or the like), and be recycled within or returned to the absorption tube 104 (or array 122). As an example, the heat from the fluid may be used for heating during lithium brine processing to reach desired ambient temperatures of approximately 122 to 140 degrees Fahrenheit (or other ranges greater, therebetween, or lower). The heat transfer fluid may be held within storage tanks coupled to the absorption tube 104 (or array 122) and/or may be returned to the absorption tube 104 (or array 122).

Referring again to FIG. 3, the absorption tube 104 includes the curved outer surface or curved portion 124 and the flat outer surface or flat portion 126. The curved portion 124 may have a half-oval, semi-circle, arched and/or otherwise curved shape. The curved portion 124 may have a radius of approximately 0.375 in., 0.1 to 0.2 in., 0.2 to 0.3 in., 0.3 to 0.4 in., 0.4 to 0.5 in., 0.5 to 0.6 in., and/or other ranges therebetween. In some implementations, the flat portion has a length of approximately 1.5 in., 0.5 to 0.75 in., 0.75 to 1.0 in., 1.0 to 1.5 in., 1.5 to 2.0 in., 2.0 to 2.5 in., and/or other ranges therebetween. In some implementations, the curved portion 124 has a length of approximately 1.18 in., 0.8 to 0.9 in., 0.9 to 1.0 in., 1.0 to 1.1 in., 1.1 to 1.2 in., 1.2 to 1.3 in., 1.3 to 1.4 in., and/or the like. The curved portion 124 and the flat portion 126 may be integrally formed. For example, the curved portion 124 and the flat portion 126 may together form a perimeter of the absorption tube 104. Such configuration helps to maintain the structural integrity of the absorption tube 104 and helps to limit or prevent deformation or collapse of the absorption tube 104. Such configurations may also eliminate the need for internal webbing to prevent collapse or deformation of the absorption tube 104.

In some implementations, the curved portion forms greater than or equal to 50% of the perimeter of the absorption tube 104 and the flat portion forms less than or equal to 50% of the perimeter. In some implementations, the curved portion forms greater than or equal to 25% of the perimeter of the absorption tube 104 and the flat portion forms less than or equal to 75% of the perimeter, the curved portion forms greater than or equal to 33.33% of the perimeter of the absorption tube 104 and the flat portion forms less than or equal to 66.66% of the perimeter, the curved portion forms greater than or equal to 45% of the perimeter of the absorption tube 104 and the flat portion forms less than or equal to 55% of the perimeter, the curved portion forms greater than or equal to 55% of the perimeter of the absorption tube 104 and the flat portion forms less than or equal to 45% of the perimeter, the curved portion forms greater than or equal to 66.66% of the perimeter of the absorption tube 104 and the flat portion forms less than or equal to 33.33% of the perimeter, the curved portion forms greater than or equal to 75% of the perimeter of the absorption tube 104 and the flat portion forms less than or equal to 25% of the perimeter, and/or the like.

In some implementations, the absorption tube 104 includes an absorbing or first side 138 and a second side 140 opposite the first side 138. The first side 138 may be configured to absorb or remove heat and/or solar energy and transfer the heat to the fluid flowing within the channel 128. In some implementations, such as when the solar energy collector 120 is used with the energy dissipating receiver 102, the first side 138 faces in a direction towards the energy dissipating receiver 102. In some implementations, the first side 138 contacts the energy dissipating receiver 102. Additionally and/or alternatively, the first side 138 may be spaced apart from the energy dissipating receiver 102 by a gap. This allows air to flow between the energy dissipating receiver 102 and the solar collector 104 to further cool the energy dissipating receiver 102 and/or reduce a temperature of the energy dissipating receiver 102. The perimeter of each tube (e.g., a total length of the curved portion and the flat portion, such as a perimeter of a cross-section of each tube, a perimeter of a side at the first end and/or the second end of each tube, and/or the like) may be approximately 2.68 in., 1.5 to 1.75 in., 1.75 to 2.0 in., 2.0 to 2.25 in., 2.25 to 2.5 in., 2.5 to 2.75 in., 2.75 to 3.0 in., and/or the like. In some implementations, a thickness of the wall of the absorption tube, such as between the exterior surface of the channel and the exterior surface of the absorption tube, is approximately 0.1 to 0.25 in., 0.25 to 0.5 in., 0.5 to 0.75 in., and/or the like. As an example, a total width of the array 122, shown in FIG. 3, including at least four absorption tubes (e.g., a first, second, third, and/or fourth absorption tube) may be approximately 6 inches, although, as described herein other widths are contemplated and may be tuned depending on the available space.

In some implementations, such as when the solar energy collector 120 is used with the energy dissipating receiver 102, the flat portion 126 defines the absorbing side or the first side 138. This allows the flat portion 126 to have maximum contact (or surface area in contact) with the energy dissipating receiver 102, or other flat surface to absorb or release heat to the fluid flowing through the channel 128. Such configurations also provide a maximum heat transfer surface to face towards and/or contact the energy dissipating receiver 102, to allow for maximal and/or efficient transfer of heat to the absorption tube 104.

In some implementations, such as when the energy dissipating receiver 102 is not used with the solar energy collector 120, the curved portion 124 defines the absorbing side or first side 138. This allows the curved portion 124 to be directly exposed to the sun to provide a greater surface area for absorbing solar energy, allowing the flat portion 126 to be adhered or otherwise coupled to a roof or other structure, to, for example, heat a pool, process the heat, or other heating applications.

In some implementations, the array 122 of the absorption tubes 104 may be curved along a length of the array. In other words, at least one absorption tube 104 of the array 122 may be pre-formed in a curve or pre-curved between the first end 132 and the second end 134. The curve may include an interior and an exterior. The exterior of the curved absorption tube 104 may contact the energy dissipating receiver 102 to secure the absorption tube 104 against the energy dissipating receiver 102. For example, the curve may bias the absorption tube 104 against the energy dissipating receiver 102. This helps to maintain contact between the absorption tube 104 (or array 122) and the energy dissipating receiver 102, thereby more efficiently transferring heat from and/or cooling the energy dissipating receiver 102.

The absorption tube 104, including the array 122, may include one or more materials suitable for absorbing heat and/or encouraging heat transfer. For example, the absorption tube 104, including the array 122 may include one or more of a flexible ethylene propylene diene terpolymer (“EPDM”), a rubber, a plastic, a silicon rubber, a thermoplastic with high conductivity, a material suitable for handling fluid acids and/or caustics, and/or an elastomer compound with a durometer suitable for rounding out, stretching, and/or the like, among others. The material of the absorption tube 104 efficiently transfers heat to the fluid passing through the absorption tube 104.

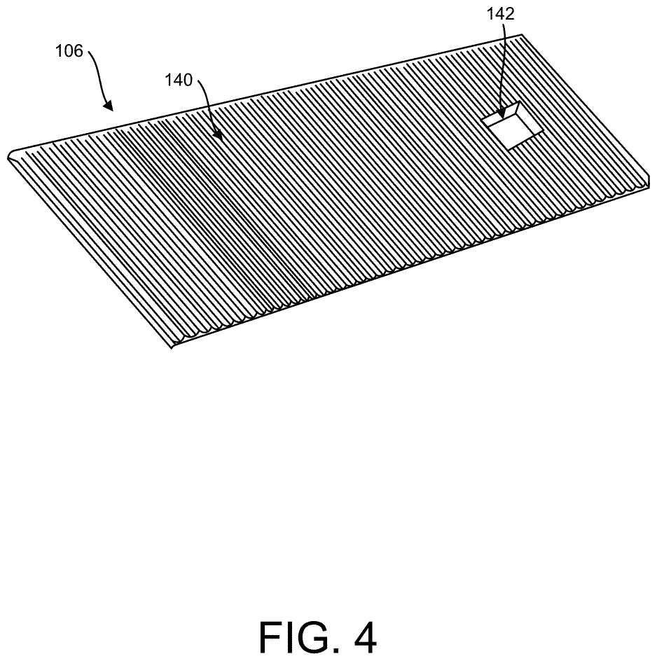

FIG. 4 illustrates an example of the base 106 consistent with implementations of the current subject matter. The base 106 may support the absorption tube 104 (and/or the array 122). For example, the base 106 may include a groove 140 configured to receive at least a portion of the absorption tube 104 (and/or the array 122). The base 106 may include a plurality of grooves 140 corresponding to the number of absorption tubes 104 of the solar energy collector 120. For example, the base 106 may include one, two, three, four, five, six, seven, eight, nine, or ten or more grooves 140. Referring to FIG. 4, the base may additionally and/or alternatively include an indent or aperture 142 configured to surround at least a portion of a junction box for the energy dissipating receiver 102.

In some implementations, the groove 140 receives the absorption tube 104, such as the curved portion 124 (see FIGS. 1 and 2). The groove 140 may have a shape that corresponds to a shape of the absorption tube 104. For example, the groove 140 may have a curved shape that corresponds to the curved portion 124 of the absorption tube 104. Thus, the absorption tube 104 may be mounted to the base 106. In other words the curved portion 124 may be mounted to the groove 140 of the base 106. This helps to secure the absorption tube 104 to the base 106. Such configurations may also help to prevent movement of the absorption tube 104 within the groove 140. Such configurations may additionally and/or alternatively prevent or limit collapsing of the absorption tube 104, such as between the base 106 and the energy dissipating receiver 102.

In some implementations, the absorption tube 104 (or array of absorption tubes) may be coupled to the base 106 to limit movement of the absorption tube 104 within the base 106. For example, the base 106, such as the groove 140 of the base 106, may include a surface suitable to receive a sticky spray or other adhesive that couples the absorption tube 104 to the base 106 and prevents or limits movement of the absorption tube 104 within the base 106. In some implementations, the base 106 may include an insulation or other material that limits or prevents heat from escaping from the absorption tube 104 and/or the fluid passing through the absorption tube 104 once the heat is absorbed by the absorption tube 104 and/or the fluid passing through the absorption tube 104. Such configurations may be useful, such as when the solar energy collector 120 is used in roofing applications. For example, the solar energy collector 120 may absorb the heat from the sun and/or the energy dissipating receiver 102 without allowing the heat to pass from and/or through the solar energy collector 120 to the roof of the building. Additionally and/or alternatively, the base 106 includes a metal, such as a corrugated metal, a molded thermoplastic material, and/or the like.

FIG. 5 illustrates a side cross-sectional view of a header assembly 145 consistent with implementations of the current subject matter. FIG. 6 illustrates a front cross-sectional view of the header assembly 145 consistent with implementations of the current subject matter. The header assembly 145 may include the header 108 and a header ring 144.

The header 145 may be positioned at least partially within an end of the absorption tube 104. For example, at least one header 108 may be positioned at least partially within each end (e.g., the first end 132 and the second end 134) of each absorption tube 104 of the solar energy collector 120. In other words, the solar energy collector system 100 may include a plurality of headers 108. At least a portion of each header 108 of the plurality of headers may positioned within a corresponding end (e.g., adjacent ends, opposite ends, and/or the like) of an absorption tube 104. The headers 108 may allow for the absorption tubes 104 forming the solar energy collector 120 to fluidly communicate with one another. Each of the headers 108 may include capping or other connectors that connect and/or close off the ends of the headers 108.

The header 108 may collect and/or direct the flow of the fluid through the channel 128 of each absorption tube 104. For example, the header 108 may define a distribution and collecting adapter. The adapter may include an interior channel 146, which fluidly communicates with the channel 128 of the absorption tube 104 when the header 108 is coupled to the absorption tube 104. The adapter may distribute the fluid caused by a pump or convection to flow from a heat storage vessel, such as a pool or water heater, through the header 108, and through the channel 128 of the absorption tube 104 where the absorption tube 104 absorbs heat through its wall and the heat is transferred to the fluid in the channel 128 by conduction and/or convection. The adapter may also collect the fluid from within the channel 128. For example, the header 108 may include a distribution header (e.g., a first header) and a collection header (e.g., a second header) positioned at opposite ends (e.g., the first end 132 and/or the second end 134 of each absorption tube 104. The distribution header may distribute the fluid within the absorption tubes 104 and/or between absorption tubes 104. The collection header may collect the heated fluid from within the absorption tubes 104 and transfer the fluid to another system, such as a water heater, an air conditioning system, a lithium processing and/or extraction system, battery management systems (e.g., stored in batteries), a pool, and/or the like. Additionally and/or alternatively, the header 108 may direct the flow of the fluid as part of a closed loop system such that the heated fluid is fed through a heat exchanger for process use.

The header 108 may be sealably coupled to each end of the absorption tube 104. For example, the end of each absorption tube 104, such as the channel of each end, may be stretched and/or tightly squeezed over each header 108. In some implementations, the header 108 includes a receptacle portion 142 and one or more sealing features 144 that seal at least a portion of the header 108 within the absorption tube 104 to prevent leakage of the fluid from the absorption tube 104. The receptacle portion 142 of the header 108 may be inserted into a corresponding end of the channel 128 of the absorption tube 104. In some implementations, the sealing features include a protrusion, a barb, a groove, a header ring, and/or the like. For example, FIGS. 5, 7A-7B, and 8A-8B illustrate the header 108 including at least one (e.g., one, two, three, four, five, six or more) serrated protrusion 144. The serrated protrusion 144 extends radially outwardly from an exterior surface of the header 108 (e.g., from the receptacle portion 142). The serrated protrusion 144 may extend about an entire perimeter of the receptacle portion 142.

When the receptacle portion 142 including the at least one serrated protrusion 144 is inserted into the end of the channel 128, the at least one serrated protrusion 144 may form at least one corresponding groove in the wall of the channel 128 of the absorption tube 104 to secure the header 108 to the absorption tube 104. Thus, the end of the channel 128 may be fit over the receptacle portion 142 and the at least one serrated protrusion 144 may secure the header to the absorption tube 104 and/or help to limit or prevent leakage of the fluid from the absorption tube 104.

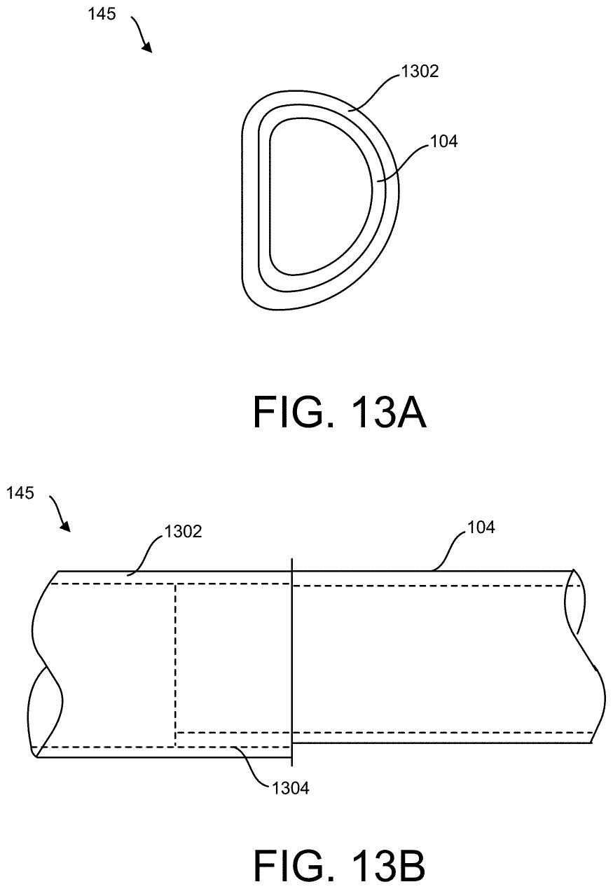

Additionally and/or alternatively, the header assembly 145 may include a sleeve 1302 (see FIGS. 13A and 13B). As shown in FIGS. 13A and 13B, the sleeve 1302 may surround at least a portion of the absorption tube 104. The sleeve 1302 may be positioned around at least an end portion of the v tube 104. In other words, an end portion of the absorption tube 104 may be inserted into a first end of the sleeve 1302. The opposite end (or another portion) of the sleeve 1302 may receive at least a portion of a corresponding header 108. Thus, the sleeve 1302 may connect the absorption tube 104 to the header 108. In some implementations, the sleeve 1302 connects the absorption tube 104 to the header 108 without barbs or another clamping mechanism.

In some implementations, the header assembly 145 may include a joint sealing 1304. The joint sealing 1304 may include an O-ring, a sealing mechanism, a barb fitting, a protrusion, an enamel fitting, and/or the like. The joint sealing 1304 may be positioned between the absorption tube 104 and an internal side wall within a channel of the sleeve 1302. The joint sealing 1304 may seal at least the end portion of the absorption tube 104 within the sleeve 1302. This helps to prevent or limit fluid leakage from within the sleeve 1302. The joint sealing 1304 may additionally and/or alternatively help to secure the absorption tube 104 to the sleeve 1302 from within the sleeve 1302. In some implementations, rather than the barb or protrusion (e.g., the protrusion 144) securing directly to the absorption tube 104, the protrusion is secured to the sleeve 1302.

Additionally and/or alternatively, the header 108 may include at least one header ring 147. The header ring 147 may be positioned around an exterior surface of at least an end portion of the absorption tube 104 into which the header 108 is inserted. For example, the header ring 147 may fit over the end portion of the absorption tube 104 such that the header ring 147 fits over the absorption tube and the receptacle portion 142 of the header 108 when the header 108 is inserted into the absorption tube 104. In such configuration, the header ring 147 may compress the end portion of the absorption tube 104 to form a seal between the absorption tube 104 and the header 108 and to secure the header 108 to the absorption tube 104. In some implementations, the header ring 147 includes one or more of a pinch clamp, a hose clamp, a slipover ring, a mechanically crushed ring, and/or the like.

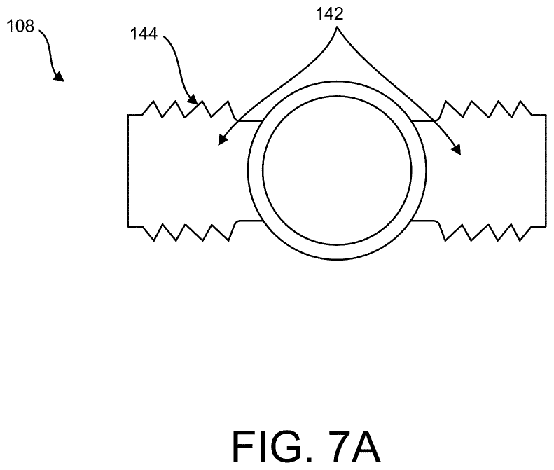

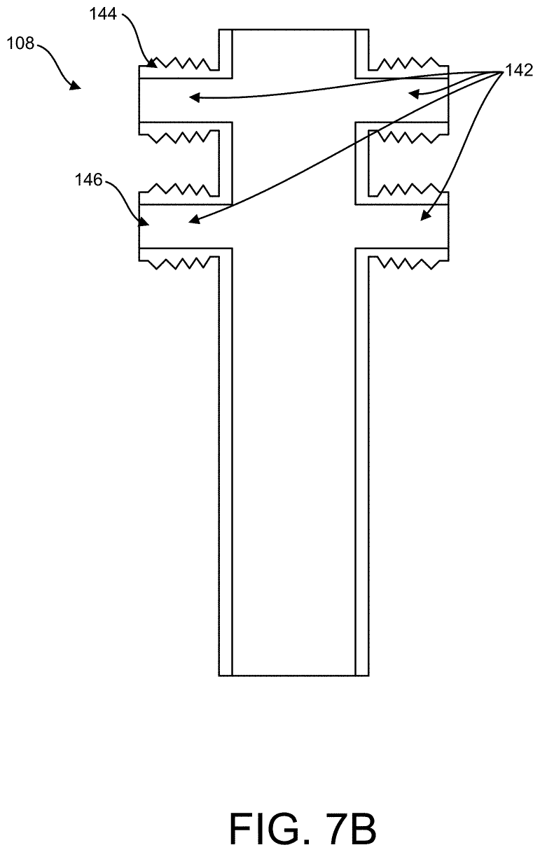

FIGS. 7A and 7B illustrate another example of the header 108 consistent with implementations of the current subject matter. As shown in FIGS. 7A and 7B, the header 108 may include a 180 degree header 108. In such configurations, the header 108 may include a plurality (e.g., two, three, four, five, six, seven, eight, or more) receptacle portions 142 extending from the header 108. For example, the header 108 may include at least two receptacle portions 142 positioned on opposite sides of the header 108. For example, the at least two receptacle portions 142 may be positioned approximately 180 degrees relative to one another. In some implementations, the header 108 may include at least two pairs of receptacle portions 142. As shown in FIGS. 7A and 7B, each receptacle portion 142 of each pair of receptacle portions 142 may be positioned approximately 180 degrees relative to one another on opposite sides of the header 108. The 180 degree header may define a coupler or elbow to fluidly and/or mechanically couple absorption tubes 104 in various directions.

FIGS. 8A and 8B illustrate another example of the header 108 consistent with implementations of the current subject matter. As shown in FIGS. 8A and 8B, the header 108 may include a 180 degree header 108. In such configurations, the header 108 may include a plurality (e.g., two, three, four, five, six, seven, eight, or more) receptacle portions 142 extending from the header 108. For example, the header 108 may include at least two receptacle portions 142 positioned on opposite sides of the header 108. For example, the at least two receptacle portions 142 may be positioned approximately 180 degrees relative to one another. In some implementations, the header 108 may include at least two pairs of receptacle portions 142. As shown in FIGS. 8A and 8B, each receptacle portion 142 of each pair of receptacle portions 142 may be positioned approximately 180 degrees relative to one another on opposite sides of the header 108. The 180 degree header may define a coupler or elbow to fluidly and/or mechanically couple absorption tubes 104 in various directions.

Unlike the heater 108 shown in FIGS. 7A and 7B, each pair of receptacle portions 142 shown in FIGS. 8A and 8B may be rotated with respect to one another about a central longitudinal axis 143. For example, each pair of receptacle portions 142 may be offset from one another about the central longitudinal axis 143 such that at least adjacent pairs of receptacle portions 142 are not aligned in a direction parallel to the central longitudinal axis 143. Referring to FIGS. 8A and 8B, the plurality of receptacle portions 142 may include a first pair 142A and a second pair 142B. As shown in FIG. 8A, the first pair 142A is rotated relative to the second pair 142B. The first pair 142A may be rotated at any angle with respect to the second pair 142B about the central longitudinal axis 143. In other words, each pair of receptacle portions 142 may be positioned in varying orientations in a vertical plane about the central longitudinal axis 143. Such configurations, such as the configurations shown in FIGS. 8A-8B allow for easier coupling of the absorption tubes 104 to the respective receptacle portion 142 of the plurality of receptacle portions 412 of the header 108. This may additionally and/or alternatively allow for easier clamping of the absorption tube 104 around a corresponding receptacle portion of the header 108. FIG. 9 illustrates an example of the solar energy collector system 100 consistent with implementations of the current subject matter. As shown in FIG. 9, the solar energy collector system 100 may include the energy dissipating receiver 102 and the solar energy collector 120. The solar energy collector 120 may include the array 122 of absorption tubes 104. The solar energy collector 120 may additionally and/or alternatively include the base 106. In some implementations the energy dissipating receiver 102 may be mounted to the one or more rails 110. The solar energy collector 120 may be mounted to and/or positioned between one or more rails 110. For example, the solar energy collector 120 may be separated such that a portion of the solar energy collector 120 is positioned between each of the rails 110. This helps to ensure that the energy dissipating receivers 102 are properly mounted and secured to the rails 110 and the solar energy collector 120 is properly positioned relative to each of the energy dissipating receivers 102. Referring again to FIG. 9, the solar energy collector 120 is shown as extending in a direction that is perpendicular relative to each of the energy dissipating receivers 102.

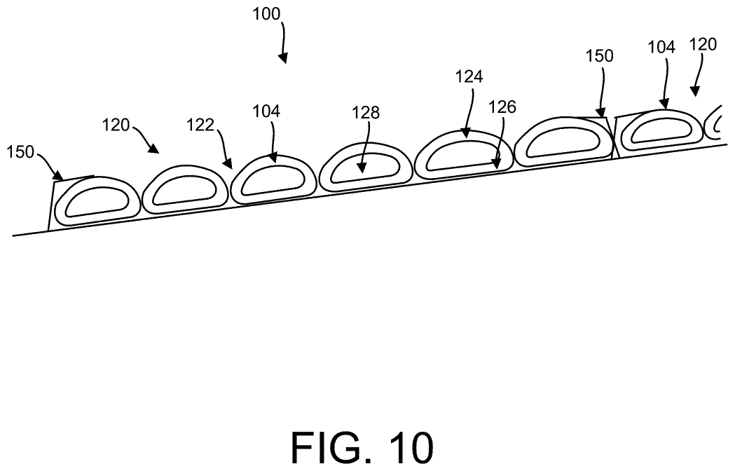

FIG. 10 illustrates an example of the solar energy collector 120 consistent with implementations of the current subject matter. As shown in FIG. 10, the solar energy collector 120 may be positioned on a surface such as a roof, including as a flat or a sloped roof. The solar energy collector 120 may additionally and/or alternatively be positioned on another surface, such as a pool, body of water, the ground, a base, rails, and/or the like. In some implementations, a plurality of solar energy collectors 120 may be positioned adjacent to one another. To prevent slippage or movement of the solar energy collectors 120, the solar energy collector system 100 may include a bracket and/or a tab or clip. For example, as shown in FIG. 10, the solar energy collector system 100 includes a tab or clip 150. The tab or clip 150 is configured to surround at least a portion of an absorption tube 104 of the solar energy collector 120, such as the absorption tubes 104 located on the sides of the solar energy collector 120. The tab or clip 150 may be coupled to the roof and/or may be coupled to a bracket that extends along a portion of the solar energy collector 120, such as a bottom portion. The bracket and the tab or clip 150 may be integrally formed. The bracket and/or the tab or clip 150 may include an aluminum or other material. The bracket and/or the tab or clip 150 may be rolled and punched into a shape to receive and/or support the solar energy collector 120, and/or to prevent movement of the solar energy collector 120.

In the example shown in FIG. 10, the curved portion 124 faces the sun to absorb the solar energy from the sun and transfer heat to the fluid flowing through the channels 128 of the absorption tubes 104. The flat portion 126 of the absorption tubes 104 may be positioned flat against the roof and/or within the bracket, thereby minimizing movement of the solar energy collector 120 relative to the roof. This helps to maintain the position of the solar energy collector 120 on the roof and to maximize the surface area of the solar energy collector 120 exposed to the sun. This also helps to reduce a temperature of the roof, as the heat from the sun is transferred to the fluid within the absorption tubes 104 rather than to the roof.

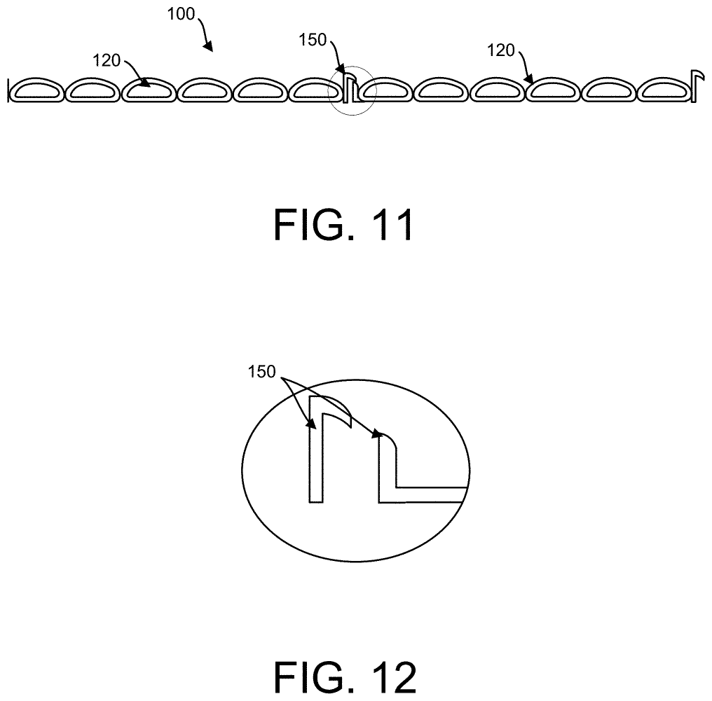

FIGS. 11 and 12 illustrate another example of the solar energy collector 120 consistent with implementations of the current subject matter. As shown in FIGS. 11 and 12, a plurality of solar energy collectors 120 may be positioned adjacent to one another. To prevent slippage or movement of the solar energy collectors 120, the solar energy collector system 100 may include a bracket and/or a tab or clip. For example, as shown in FIG. 10, the solar energy collector system 100 includes a tab or clip 150. The tab or clip 150 is configured to surround at least a portion of an absorption tube 104 of the solar energy collector 120, such as the absorption tubes 104 located on the sides of the solar energy collector 120. The tab or clip 150 may be interlocking such that the tab or clip 150 coupled to one solar energy collector 120 is interlocking with the tab or clip 150 of an adjacent solar energy collector 120. This helps to secure adjacent solar energy collectors to one another to prevent or limit movement of the solar energy collectors 120. The interlocking tabs or clips 150 may be vulcanized for complete waterproofing.

Accordingly, as described herein, the solar energy collector 120 may be configured to prevent or limit collapsing of the absorption tubes 104. The described configurations of the solar energy collector system 100 may also help to extend the lifespan of an energy dissipating receiver, such as a photovoltaic panel and/or reduce degradation of the panel by, for example, reducing the operating temperature of the panel and maximizing heat transfer from the panel to fluid flowing through the absorption tubes of the solar energy collector. The solar energy collector 120 described herein may be better supported by the base 106, which may help to limit or prevent movement of the solar energy collector 120 and help to maintain a maximum heat transfer surface of the solar energy collector 120 exposed to the heat (e.g., the flat portion exposed to the energy dissipating receiver and/or the curved portion exposed to direct sunlight).

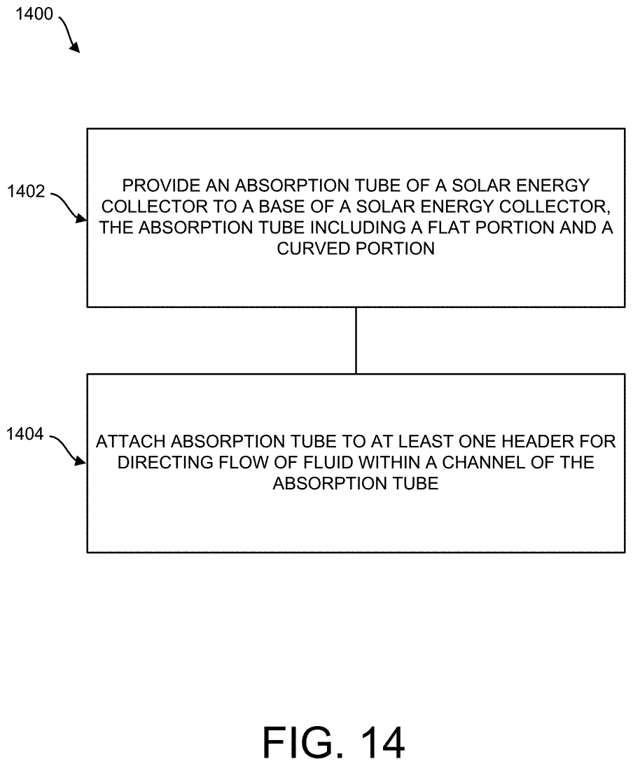

FIG. 14 illustrates an example method 1300 of improving a lifespan of a photovoltaic panel, such as the energy dissipating receiver 102, and transferring heat from the photovoltaic panel, consistent with implementations of the current subject matter.

At 1402, an absorption tube, such as the absorption tube 104 and/or the array 122, may be provided to a base, such as the base 106, of a solar energy collector, such as the solar energy collector 120. The absorption tube 104, as described herein, may encourage the transfer of heat from the photovoltaic panel to fluid flowing through the absorption tube 104. For example, the absorption tube may include a channel extending through a length of the absorption tube and may allow for the fluid, such as water, antifreeze, a refrigerant, and/or the like, to flow through the length of the absorption tube. The fluid may absorb the transferred heat from the photovoltaic panel through the wall of the absorption tube. The absorption tube may also include a curved portion, such as the curved portion 124, and a flat portion, such as the flat portion 126. In some implementations, the curved portion and the flat portion may together form a perimeter of the absorption tube. This helps to prevent or limit collapsing of the absorption tube in use, such as when the absorption tube is positioned between the photovoltaic panel and the base. The flat portion may face the photovoltaic panel. This helps to provide a maximum surface area to absorb heat from the photovoltaic panel. Such configurations may also help to maintain contact between the photovoltaic panel and the absorption tube to further improve heat transfer between the photovoltaic panel and the absorption tube.

In some implementations, as described herein, the base may include a groove. The groove may receive at least a portion of the absorption tube, such as the curved portion of the absorption tube. The base may also support the absorption tube and help to maintain contact between the absorption tube and the photovoltaic panel.

At 1404, the absorption tube may be attached to or otherwise coupled to at least one header, such as the header 108. For example, the absorption tube may be coupled at each end to a respective header. Each header may be positioned at least partially within a respective end of the absorption tube. The header may direct the flow of the fluid through the channel of the absorption tube.

In some implementations, the absorption tube and the header may be positioned within a recess between panel rails. The panel rails, such as the rails 110, may be coupled to a roof of a building and/or another surface. In some implementations, the photovoltaic panel may be positioned over the absorption tube. For example, the panel rails may mount the photovoltaic panel, and the absorption tube may be configured to fit between the panel rails to maximize the heat transfer surface of the absorption tube exposed to or in contact with the photovoltaic panel.

Although the disclosure, including the figures, described herein may described and/or exemplify these different variations separately, it should be understood that all or some, or components of them, may be combined.

Although various illustrative embodiments are described above, any of a number of changes may be made to various embodiments. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the claims.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. References to a structure or feature that is disposed “adjacent” another feature may have portions that overlap or underlie the adjacent feature.

Terminology used herein is for the purpose of describing particular embodiments only and is not intended to be limiting. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as, for example, “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings provided herein.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

As used herein in the specification and claims, including as used in the examples and unless otherwise expressly specified, all numbers may be read as if prefaced by the word “about” or “approximately,” even if the term does not expressly appear. The phrase “about” “or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, are possible.

In the descriptions above and in the claims, phrases such as, for example, “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

What is claimed is:

1. A solar energy collector system, comprising:
an energy dissipating receiver configured to absorb solar energy;
an absorption tube configured to encourage a transfer of heat from the energy dissipating receiver, the absorption tube comprising:
a curved portion;
a flat portion configured to face towards the energy dissipating receiver; and
a channel extending through a length of the absorption tube, the channel configured to allow a fluid to flow through the absorption tube, the fluid configured to absorb the transferred heat from the energy dissipating receiver;
a base comprising a groove configured to receive at least a portion of the absorption tube and support the absorption tube; and
a header positioned at least partially within an end of the absorption tube, the header configured to direct the flow of the fluid through the channel of the absorption tube.

2. The system of claim 1, wherein the energy dissipating receiver comprises one or more of a photovoltaic (“PV”) panel and a solar panel.

3. The system of claim 1, wherein the curved portion forms at least 50% of a perimeter of the absorption tube.

4. The system of claim 1, wherein the curved portion and the flat portion together define a perimeter of the absorption tube.

5. The system of claim 1, wherein the absorption tube comprises a plurality of absorption tubes.

6. The system of claim 5, wherein each of the plurality of absorption tubes are positioned adjacent to one another as part of an array of absorption tubes.

7. The system of claim 5, wherein each of the plurality of absorption tubes is separated by a perforation configured to allow for tearing of each absorption tube from the plurality of absorption tubes.

8. The system of claim 1, wherein the absorption tube is oriented in a direction that is perpendicular relative to the energy dissipating receiver.

9. The system of claim 1, wherein the energy dissipating receiver comprises: a first side configured to absorb the solar energy; and a second side opposite the first side; and wherein the absorption tube is configured to contact the second side of the energy dissipating receiver.

10. The system of claim 1, wherein the energy dissipating receiver comprises: a first side configured to absorb the solar energy; and a second side opposite the first side; and wherein the absorption tube is configured to be spaced apart from the second side of the energy dissipating receiver by a gap to allow air to flow between the energy dissipating receiver and the absorption tube, the air flowing through the gap configured to reduce a temperature of the energy dissipating receiver.

11. The system of claim 1, wherein the fluid comprises one or more of water, antifreeze, and a refrigerant.

12. The system of claim 1, wherein the absorption tube comprises one or more of a flexible ethylene propylene diene terpolymer (“EPDM”), a rubber, a plastic, a silicon rubber, a thermoplastic with high conductivity, an elastomer compound with a durometer suitable for rounding out and stretching.

13. The system of claim 1, wherein the absorption tube is curved along a length of the absorption tube, the curve configured to bias the absorption tube against the energy dissipating receiver.

14. The system of claim 1, wherein the groove comprises a plurality of grooves.

15. The system of claim 1, wherein the groove is configured to receive at least a portion of the curved portion of the absorption tube.

16. The system of claim 1, wherein a shape of the curved portion corresponds to a shape of the groove.

17. The system of claim 1, wherein the base comprises an insulation material.

18. The system of claim 1, wherein the base comprises a surface suitable to receive an adhesive prevent movement of the absorption tube within the groove.

19. The system of claim 1, wherein the base comprises one or more of a corrugated metal and a molded thermoplastic material.

20. An array of absorption tubes configured to encourage a transfer of heat from a photovoltaic panel, the array of absorption tubes comprising:
a first absorption tube comprising:
a first curved portion;
a first flat portion, the first flat portion configured to face the photovoltaic panel; and
a first channel extending through a length of the first absorption tube, the first channel configured to allow a fluid to flow through the first absorption tube, the fluid configured to absorb the transferred heat from the photovoltaic panel; and
a second absorption tube coupled to the first absorption tube, the second absorption tube comprising:
a second curved portion;
a second flat portion, the second flat portion configured to face the photovoltaic panel; and
a second channel extending through a length of the second absorption tube, the second channel configured to allow the fluid to flow through the second absorption tube, the fluid configured to absorb the transferred heat from the photovoltaic panel, the second channel being fluidly connected to the first channel.
